(19) United States
(12) Patent Application Publication
(10) Pub. No.: US 2006/0181451 A1
(43) Pub. Date: Aug. 17, 2006

(54) System and method for combining displaced phase center antenna and space-time adaptive processing techniques to enhance clutter suppression in radar on moving platforms

(75) Inventor: John R. Samson JR., Palm Harbor, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/058,763

(22) Filed: Feb. 14, 2005

(51) Int. Cl. G01S 13/52

(52) U.S. Cl. 342/160; 342/195; 342/196

(57) ABSTRACT

A system and method are disclosed for enhancing the suppression of clutter and target detection in a radar system located on a moving platform. For example, a radar system including an MTI subsystem is located on a moving platform (e.g., ship-borne, airborne or space-based radar system) with a DPCA processing unit located nearer to the front end of the radar receiver, and a STAP processing unit located nearer to the back end. The DPCA processing unit provides gross cancellation and suppression of the received clutter signals, and the STAP processing unit provides fine tuning for the clutter suppression process. In other words, the front end DPCA processing unit removes most of the rapidly varying clutter, which gives the back end STAP processing unit a more benign clutter environment to process. As such, using a DPCA processing unit on a space-based radar platform improves system performance, because the space-based platform is relatively stable and not subject to air turbulence or wave motion. Also, using a DPCA processing unit provides independence from clutter statistics, which is important because relatively little empirical clutter data is available from space-based radar platforms. Using a STAP processing unit for clutter suppression on the space-based radar platform provides fine tuning of the suppression process.

### BACKGROUND OF THE INVENTION

1. Technical Field

The present invention relates generally to the field of radar systems, and more particularly, but not exclusively, to a system and method for combining Displaced Phase Center Antenna (DPCA) and Space-Time Adaptive Processing (STAP) techniques in order to enhance clutter suppression and target detection in radar systems located on moving platforms.

2. Description of Related Art

Moving Target Indication (MTI) radar systems are used to reject signals received from fixed objects (“clutter”), and enhance the detection of signals received from valid, moving targets. Typically, coherent MTI systems use the Doppler shift effect of moving targets to distinguish them from the fixed objects or clutter. Essentially, clutter is a collective term referring to those objects that are not valid targets and cause unwanted radar reflections to mix with target reflections. Examples of clutter are non-moving objects on land surfaces and/or sea surfaces, such as buildings, trees, ocean waves, clouds, rain, etc. As such, clutter is a form of radar interference that hinders the identification of valid, moving targets.

Numerous techniques exist for the suppression of clutter by stationary, ground-based radars, where the primary clutter return signals are reflections from fixed objects. However, with moving radar platforms (e.g., ship-based radar, airborne radar, space-based radar), the suppression of clutter is a relatively difficult problem, because the clutter also appears to be moving due to the movement of the radar platform. Consequently, the detection of valid, moving targets within a moving clutter environment is a significant technical problem that exists. Thus, it would be advantageous to have an improved radar system and method that can detect valid targets within a moving clutter environment. The present invention provides such an improved radar system and method.

### SUMMARY OF THE INVENTION

The present invention provides a system and method for enhancing the suppression of clutter and target detection in a radar system located on a moving platform. In a preferred embodiment of the invention, a radar system including an MTI subsystem is located on a moving platform (e.g., ship-based, airborne or space-based radar system) with a DPCA processing unit located nearer to the front end of the radar receiver, and a STAP processing unit located nearer to the back end of the onboard processing subsystem. The DPCA processing unit provides gross cancellation and suppression of the received clutter signals, and the STAP processing unit provides fine tuning for the clutter suppression process. In other words, the front end DPCA processing unit removes most of the rapidly varying clutter, which gives the back end STAP processing unit a more benign clutter environment to process. As such, using a DPCA processing unit or stage on a space-based radar platform improves system performance, because the space-based platform is relatively stable and not subject to air turbulence or wave motion. Also, using a DPCA processing unit or stage provides independence from clutter statistics, which is important because relatively little empirical clutter data is available from space-based radar platforms. Using a STAP processing unit or stage for clutter suppression on the space-based radar platform provides fine tuning of the suppression process.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of an example of a space-based radar system environment, which can be used to illustrate a preferred embodiment of the present invention;

FIG. 2 depicts a block diagram of a radar system that can be used to implement a preferred embodiment of the present invention;

FIG. 3 depicts a block diagram of an MTI processing system that can be used to implement a preferred embodiment of the present invention;

FIG. 4 depicts a pictorial representation of an example DPCA antenna structure that can be used to implement a preferred embodiment of the present invention;

FIG. 5 depicts a block diagram of an example ECCM/beam-forming processing function that can be used to implement beam-forming processing unit 306 shown in FIG. 3;

FIG. 6 depicts a block diagram of an example Doppler filtering processing unit that can be used to implement Doppler processing unit 308 shown in FIG. 3;

FIG. 7 depicts a block diagram of an example pulse compression processing unit that can be used to implement pulse compression processing unit 310 shown in FIG. 3;

FIG. 8 depicts a block diagram of an example STAP processing unit that can be used to implement STAP processing unit 312 shown in FIG. 3; and

FIGS. 9A and 9B depict related block diagrams of example CFAR processing units that can be used to implement CFAR processing unit 314 shown in FIG. 3.

### DETAILED DESCRIPTION OF THE PREFERRED EMBODIMENT

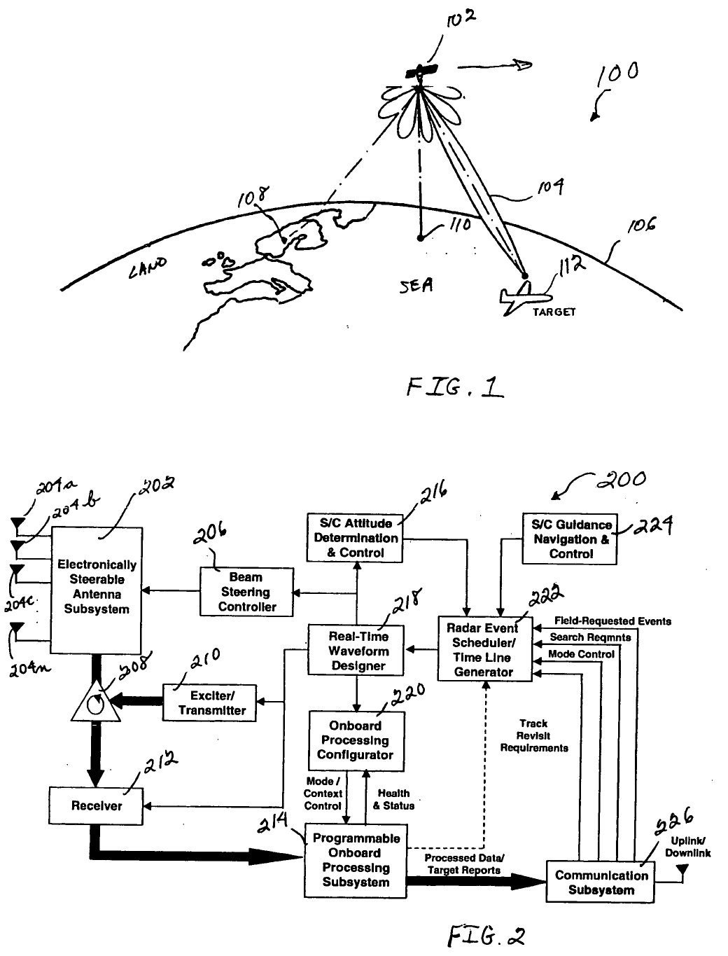

Referring now to the figures, FIG. 1 depicts a pictorial representation of an example of a space-based radar system environment 100, which can be used to illustrate a preferred embodiment of the present invention. For this exemplary embodiment, an MTI radar system 102 is located on a satellite platform that is in orbit over a portion of the Earth 106. The satellite platform for radar system 102 can be in a Highly Elliptical Orbit (HEO), a Medium Earth Orbit (MEO), or a Low Earth Orbit (LEO). Also, radar system 102 can be located on a space-based vehicle or station, such as, for example, a space shuttle or similar space vehicle, space-based laboratory, space station, etc. As such, radar system 102 can be located on any appropriate space-based platform. In any event, although a space-based radar system is described with respect to this embodiment, the present invention is not intended to be so limited, and can include radar systems located on other moving platforms as well, such as, for example, airborne or ship-based radar systems.

Preferably, for this embodiment, radar system 102 includes a phased-array antenna subsystem that can generate an electronically-shaped and electronically-steerable antenna radiation pattern 104. As shown, radiation pattern 104 depicts a principal lobe of the antenna pattern, which is directed towards a moving target (e.g., aircraft) 112. Also, certain secondary lobes of antenna pattern 104 are shown directed, for example, towards land-based clutter 108 and sea-based clutter 110. For this embodiment, the electronically-steerable antenna subsystem can be a phased-array, but it can also include any appropriate antenna structure that can be divided into at least two antenna segments (e.g., typically sharing antenna elements) or one antenna with a plurality of phase centers, which can be used for DPCA processing.

FIG. 2 depicts a block diagram of a radar system 200 that can be used to implement a preferred embodiment of the present invention. For illustrative purposes only, radar system 200 is described herein for a space-based platform, such as, for example, the satellite platform for radar system 102 shown in FIG. 1. However, the present invention is not intended to be so limited, and radar system 200 can also be located on any other suitable airborne, ship-based or space-based platform.

For this exemplary embodiment, radar system 200 includes an electronically steerable antenna subsystem 202, with a plurality of antenna elements 204a-204n. For example, antenna subsystem 202 can be a phased array antenna subsystem, or an adaptive array antenna subsystem. Preferably, antenna subsystem 202 is any appropriate antenna structure that can be divided into at least two antenna segments (e.g., typically sharing antenna elements) or one antenna with a plurality of phase centers, which can be used for DPCA processing.

A beam steering controller 206 is connected to electronically steerable antenna subsystem 202 for directing the radiation pattern of antenna elements 204a-204n. An exciter/transmitter stage 210 is connected to a circulator 208, which couples the transmission pulses generated by exciter/transmitter stage 210 to antenna subsystem 202 and antenna elements 204a-204n. Circulator 208 is also connected to a receiver stage 212 and couples received signals from antenna elements 204a-204n through antenna subsystem 202 to receiver stage 212. Receiver stage 212 is connected to a programmable onboard processing subsystem 214, so that the raw data in the receiver stage 212 is coupled to programmable onboard processing subsystem 214.

Programmable onboard processing subsystem 214 is connected to an onboard processing configurator stage 220 and a communication subsystem 226. System health and status data, and mode or context control data, are coupled from/to programmable onboard processing subsystem 214 to/from onboard processing configurator stage 220, respectively. Processed data and target report data are coupled from programmable onboard processing subsystem 214 to communication subsystem 226, which enables communications between programmable onboard processing subsystem 214 and a ground station (not shown) via an uplink/downlink antenna.

A real-time waveform designer stage 218 is connected to onboard processing configurator stage 220, beam steering controller stage 206, exciter/transmitter stage 210, receiver stage 212, and a spacecraft attitude determination and control stage 216. As such, the real-time waveform designer stage couples waveform design parameters and synchronization signals between stages 220, 206, 210, 212 and 216. A radar event scheduler/time line generator stage 222 is connected to real-time waveform designer stage 218, programmable onboard processing subsystem 214, spacecraft attitude determination and control stage 216, spacecraft guidance navigation and control stage 224, and communication subsystem 226. Thus, the data coupled from control stages 216, 224 and subsystems 214 and 226 to real-time waveform designer stage 218 are used to generate timing and synchronization information for the radar system 200 and its space-based platform. Spacecraft attitude and position are coupled to the beam steering controller stage 206 to point the beam at the desired location on the earth. In this manner, the attitude, direction and velocity of the space-based platform can be considered and synchronized with the timing of the radar system's transmitter and receiver stages.

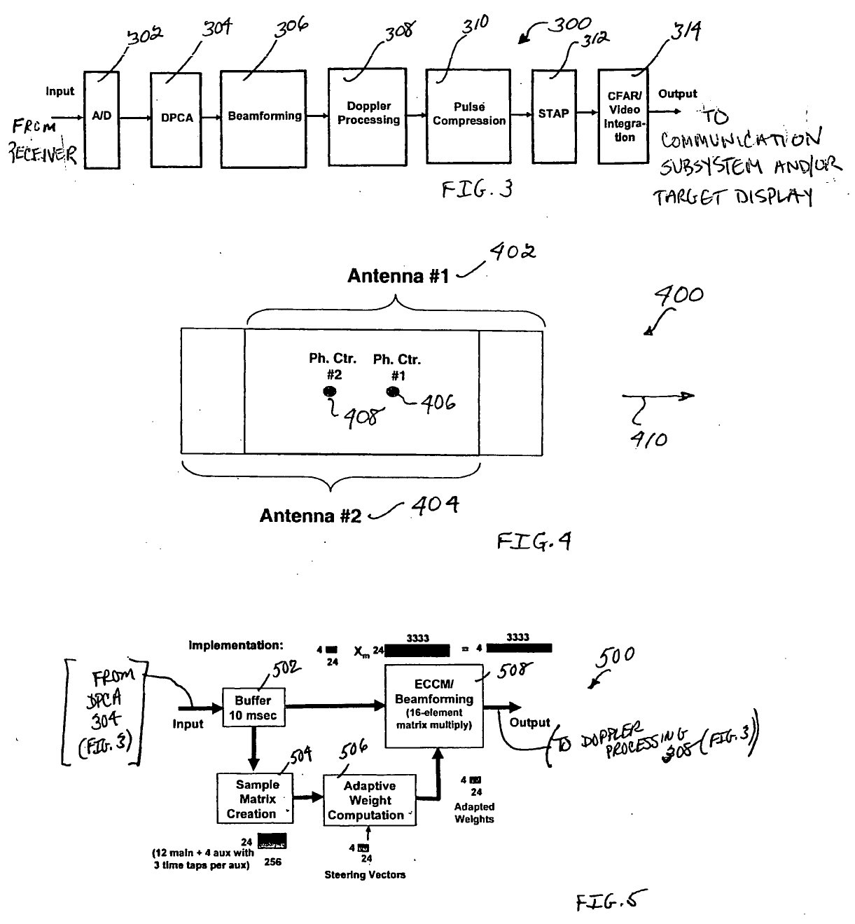

FIG. 3 depicts a block diagram of an MTI processing system 300 that can be used to implement a preferred embodiment of the present invention. For this exemplary embodiment, MTI processing system 300 is preferably a coherent MTI processing system, but the present invention is not intended to be so limited and can include a suitable non-coherent processing system as well. As an example, MTI processing system 300 can form part of radar receiver stage 212 shown in FIG. 2.

MTI processing system 300 includes an Analog-to-Digital (A/D) converter unit 302 coupled to the back end of a suitable receiver stage. Thus, for this example, analog signals (e.g., targets, clutter, etc.) input from the receiver's front end (e.g., coupled from circulator 208 in FIG. 2) are converted to digital signals by A/D converter unit 302. As such, A/D converter unit 302 quantizes continuous signals input from the receiver's front end into a series of discrete values for digital processing.

A/D converter 302 is connected to a DPCA processing unit 304. Alternatively, for example, DPCA processing unit 304 could be implemented before the A/D converter 302 (e.g., in the antenna manifold). For this exemplary embodiment, the primary purpose of DPCA processing unit 304 is to provide gross cancellation and suppression of received clutter signals. For illustrative purposes, refer now to FIG. 4 for a description of an example DPCA antenna structure 400 that can be used to implement the present invention. For example, the concept of DPCA antenna structure 400 can be used for implementation of some or all of antenna elements 204a-204n depicted in FIG. 2.

DPCA antenna structure 400 can be located on a single platform and include a plurality of identical antennas (e.g., two identical antennas having shared antenna elements) 402, 404 with separate forward and aft phase centers 406, 408, respectively. Alternatively, DPCA antenna structure 400 can include one antenna with a plurality of phase centers 406, 408. At an appropriate time (e.g., determined by the velocity of the platform for radar system 200 in FIG. 2 relative to the rotation of the Earth), a transmitter subsystem (e.g., exciter/transmitter 210 in FIG. 2) for radar system 200 transmits a signal from the first antenna 402. A receiver (e.g., receiver stage 212 in FIG. 2) receives a return signal from antenna 402. The transmitter subsystem and receiver respectively transmit and receive signals via the second antenna 404, when the aft phase center 408 has moved into a position that substantially matches the location of the forward phase center 406 when the first transmission and reception occurred. Such movement of DPCA antenna structure 400 is indicated by the arrow 410.

As such, in accordance with the present invention, a DPCA processing technique is used to subtract the radar return signals received in response to two transmissions, which cancels most of the rapidly-varying clutter signals received. This technique effectively cancels out the motion of the platform and, therefore, makes the onboard radar sensor appear to be stationary. In other words, subtracting the radar returns from the two transmissions cancels a large part of the stationary clutter (e.g., mountains, buildings, etc.) and ideally leaves only moving targets of interest for further processing. However, although this DPCA processing technique mitigates the clutter returns from stationary objects, some residual clutter can remain (e.g., return signals due to tree branches and leaves blowing in the wind, ocean wave motion, etc.). As a practical matter, performance of the DPCA technique is primarily a function of: (1) how well the two antenna segments are matched; (2) the preciseness of the timing of the transmission of the second pulse; and (3) the location of the aft phase center 408 relative to the location of the forward phase center 406 when the respective transmissions and receptions occur.

Returning to FIG. 3, DPCA processing unit 304 is connected to beam-forming (or beam formation) processing unit 306. For example, beam-forming processing unit 306 can be implemented using Electronic Counter-Countermeasures (ECCM) beam-forming processing function. As such, the inputs (e.g., coupled to DPCA processing unit 304) to beam-forming processing unit 306 can include, for example, 16 channels representing 12 sub-array antenna channels and 4 auxiliary antenna channels (e.g., with 3 time-taps per auxiliary channel). The inputs to beam-forming processing unit 306 can also include, for example, steering vectors for the output beams (e.g., 4 output beams), in a 24 by 4 matrix, with 24 weights per output beam. Thus, beam-forming processing unit 306 can perform processing for each sub-band (e.g., 36 sub-bands), each pulse (e.g., 256 pulses), and each range gate (e.g., 3333 range gates) in this exemplary embodiment.

FIG. 5 depicts a block diagram of an example ECCM/beam-forming processing function 500 that can be used to implement beam-forming processing unit 306 in FIG. 3. For example, beam-forming processing unit 500 can include a 10 msec buffer 502 connected to an input of beam-forming processing unit 306 in FIG. 3. A sample matrix 504 is coupled to buffer 502 and can be used for computing adaptive weights by creating a sample matrix (e.g., 24 by 256 matrix) based on pre-transmit collection of data. For example, the sample matrix can be formed by selecting 256 samples for each of the main channels involved (e.g., 12 main channels) and with 3 time-taps per auxiliary channel (e.g., 4 auxiliary channels). Then, a set of adaptive weights can be computed by an adaptive weight computation function or process 506 based on the sample matrix 504 created, and also a 4 by 24 matrix of the steering vectors involved. Thus, as a result, a 4 by 24 matrix of adapted weights can be applied to ECCM/beam-forming processing unit 508 to create (e.g., via a 16-element matrix multiplication) a 4 by 3333 matrix output (e.g., to be coupled from beam-forming processing unit 306 in FIG. 3 to Doppler processing unit 308). As such, beam-forming processing unit 306 can produce a 24-element matrix multiplication for each beam formed, and this process can be performed for each sub-band (e.g., 36), pulse (e.g., 256) and range gate (3333) involved.

Returning to FIG. 3, for this exemplary embodiment, the output of beam-forming processing unit 306 is shown connected to an input of Doppler processing unit 308, and an output of Doppler processing unit 308 is shown connected to an input of pulse compression processing unit 310. However, for suitable back end processing, it should be understood that the order of the Doppler and pulse compression processing units can be interchanged. In other words, the output of beam-forming processing unit 306 can be connected to an input of pulse compression processing unit 310, and an output of pulse compression processing unit 310 can be connected to an input of Doppler processing unit 308. Essentially, for such an embodiment, Doppler processing unit 308 can perform a Fast-Fourier Transform (FFT) across the radar pulses to convert the input data to the frequency (or Doppler) domain. Pulse compression processing unit 310 can use a matched filter technique that allows a long-pulse radar with moderate output power to appear to be a higher power, short-pulse radar with greatly increased range resolution.

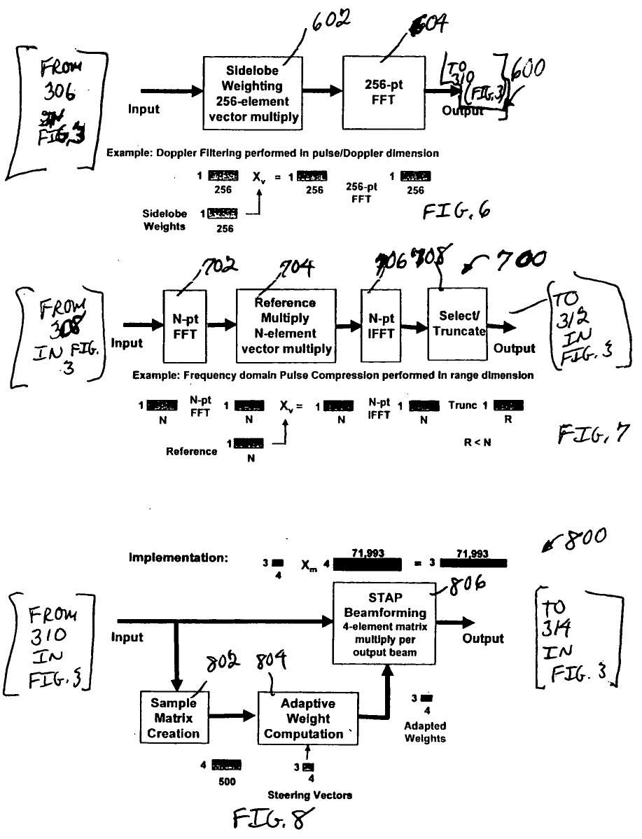

FIG. 6 depicts a block diagram of an example Doppler filtering processing unit 600 that can be used to implement Doppler processing unit 308 in FIG. 3. For example, Doppler filtering processing unit 600 can include a side-lobe weighting vector multiplication processing unit 602 connected to an input of Doppler processing unit 308 in FIG. 3. An FFT processing unit 604 is coupled to vector multiplication processing unit 602 and can be used for performing an FFT function on each weighted element received from side-lobe weighting vector multiplication processing unit 602. For this exemplary embodiment, 256 pulses are coupled to the input of side-lobe weighting vector multiplication processing unit 602, which performs a 256-element vector multiplication of the input pulses by a set of tapered weights, for example a cosine squared on a pedestal window. As such, a 1 by 256 element vector created by side-lobe weighting vector multiplication processing unit 602 is coupled to the input of FFT processing unit 604, which performs, for this example, 256-point FFT's on the weighted samples from side-lobe weighting vector multiplication processing unit 602. Processing unit 602 creates a 1 by 256 element vector including the 256-point weighted, FFT data. Thus, as a result, using the processing techniques shown in FIG. 6, Doppler processing unit 308 in FIG. 3 can perform Doppler filtering in the pulse/Doppler dimension.

In this regard, processing units 602 and 604 can perform Doppler filtering and processing for 256 pulses, each range gate (e.g., 71,983 range gates), each beam (e.g., 4 beams), and each sub-band (e.g., 1 sub-band) involved. The output of processing unit 604 (e.g., and Doppler processing unit 308) can include, for example, 256 Dopplers for 71,993 range gates, 4 beams, and 1 sub-band. The Doppler processing and filtering can be performed twice on staggered sets of received pulses to generate an output with additional temporal degrees of freedom to support post-Doppler STAP processing. At this point, it should be understood that the present invention is not intended to be limited to the above-described staggered implementation and can also include other implementations such as, for example, beam-staggered STAP implementations and element-staggered implementations.

FIG. 7 depicts a block diagram of an example pulse compression processing unit 700 that can be used to implement pulse compression processing unit 310 in FIG. 3. Notably, as mentioned earlier, pulse compression processing unit 310 may be interchanged with Doppler processing unit 308 in FIG. 3. However, for the embodiment(s) shown in FIGS. 3 and 7, pulse compression processing unit 700 can include an N-point FFT processing unit 702 connected to an input of pulse compression processing unit 310 in FIG. 3, which, for this example, can perform a FFT on each of 89,991 range gates to create an M by N matrix of the FFT data. A vector multiplication processing unit 704 performs a vector multiplication of the M by N matrix of the FFT data with reference data from a 1 by N vector, and creates an M by N matrix including the resulting vector multiplied data.

Each 1 by N vector from vector multiplication processing unit 704 is applied to the input of an N-point Inverse FFT (IFFT) processing unit 706, which performs an IFFT function on the data from the M by N matrix. In this manner, for this example, processing units 702, 704 and 706 perform a frequency domain convolution on the input pulses (e.g., pulses from 89,991 range gates). For example, this processing can be performed as one large FFT, or more practically, with a number of smaller FFTs using overlap-add or overlap-save techniques. Preferably, the input pulses are uncompressed LFM Chirp waveform length TBD range gates. As such, a linear convolution may be performed on this data in the time domain or the frequency domain. For this example, processing units 702, 704 and 706 perform frequency domain convolution (e.g., forward FFT performed by processing unit 702, element-by-element vector multiplication performed by processing unit 704, and inverse FFT performed by processing unit 706). The output of the overall convolution process is provided in an M by N matrix at the output of N-point IFFT processing unit 706. As such, an “overlap save” function can be performed if the FFT size either cannot handle all ranges or is inefficient in a single execution. Preferably, for this embodiment, for frequency domain convolution, the uncompressed waveform matched-filter weights and/or the frequency domain representation (transformation) are pre-computed.

The M by N matrix created by processing unit 706 is applied to a select/truncate processing unit 708, which performs a truncation. Thus, as a result, the output of select/truncate processing unit 708 can provide 71,993 ranges, and thus pulse compression processing is provided by processing units 702, 704, 706 and 708 (e.g., by pulse compression processing unit 310 in FIG. 3) for each pulse (e.g., 256 pulses), each beam (e.g., 4 beams), and each sub-band (e.g., 1 sub-band) involved.

Returning to FIG. 3, for this exemplary embodiment, an output of pulse compression unit 310 is connected to an input of STAP processing unit 312. Thus, in accordance with the present invention, the Doppler processed, pulse-compressed data from processing units 308, 310 can be applied to STAP processing unit 312 for fine-tuning of the clutter cancellation process in the example MTI processing stage depicted in FIG. 3 (e.g., in addition to the gross cancellation process performed by DPCA processing unit 304).

Essentially, in spatial adaptive processing, energy arriving at the antenna elements at different times and phases is used to determine the direction from which unwanted or undesired signals are arriving. The environment is sampled. The sampled data are used to create a training matrix. The training matrix is inverted and solved against desired steering vectors to generate adaptive weights which, when applied to the incoming signals, maximize sensitivity to signals in the desired directions, while nulling out or canceling unwanted or undesired signals. This spatial adaptation technique can be extended to STAP processing by forming a covariance (training) matrix across the input antenna elements (spatial diversity) and the radar pulses (temporal diversity), and then solving for adaptive weights. Adding a temporal aspect allows the STAP technique to be used for clutter cancellation as well as jammer nulling. As such, DPCA processing may be considered a degenerate form of STAP with only two degrees of freedom.

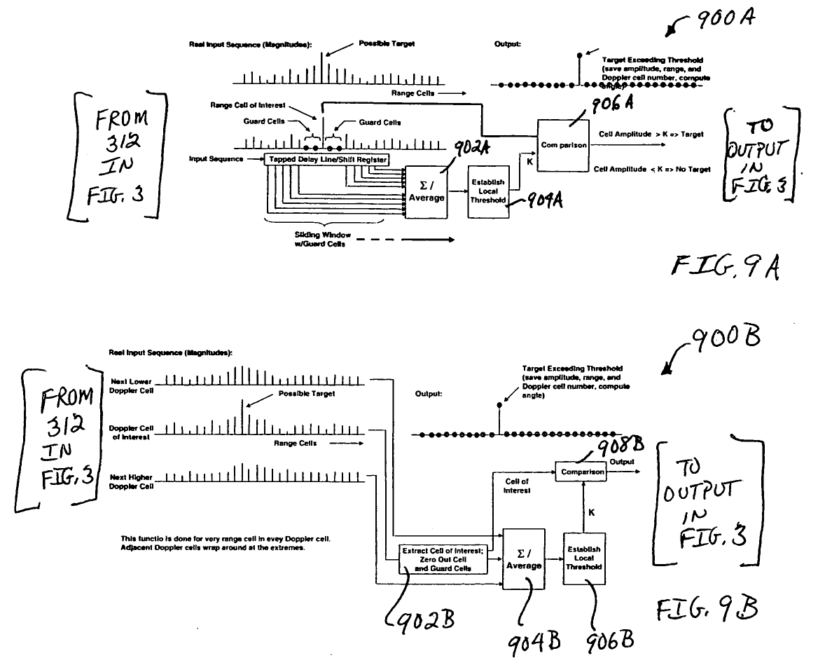

FIG. 8 depicts a block diagram of an example STAP processing unit 800 that can be used to implement STAP processing unit 312 in FIG. 3. For example, STAP processing unit 800 can include a sample matrix 802 (e.g., coupled to an input of STAP processing unit 312 in FIG. 3), which can be used for creating a sample matrix (e.g., a 4 by 500 matrix) from the input samples (e.g., 256 pulses). The input can include, for example, for each of 36 sub-bands, 4 Doppler-staggered beams, 71,993 ranges, and 256 pulses. The resulting sample matrix can be applied to an adaptive weight computation processing unit 804, which can compute a set of adaptive weights based on the sample matrix 802 created, and also a 3 by 4 matrix of the steering vectors involved (e.g., steering vectors for 3 output beams in a 3 by 4 matrix for 4 weights per output beam formed). Thus, as a result, a 3 by 4 matrix of adapted weights can be applied to STAP beam-forming processing unit 806 to create (e.g., via a 4-element matrix multiplication per output beam) a 3 by 71,993 matrix output (e.g., to be coupled from STAP processing unit 312 in FIG. 3 to Constant False Alarm Rate (CFAR) processing unit 314).

As such, as a result of the processing performed by processing units 802, 804 and 806 in FIG. 8, STAP processing unit 312 can produce (e.g., for an input of 256 pulses for 4 input beams, and steering vectors for 3 output beams) an output of 256 Dopplers for 71,993 ranges, and 3 clutter-nulled beams. This STAP beam-forming process can be performed for each sub-band (e.g., 36), each Doppler (e.g., 256), and each range gate (e.g., 71,993) involved.

Thus, in accordance with the present invention, the STAP beam-forming processing unit 312 can compute the power for each beam, whereby the beam nearest the center of the clutter is used to select 500 samples to form the sample matrix and for computing the adaptive weights (e.g., the selection of the 500 samples can be performed by the Doppler processing unit 308 in FIG. 3). Then, the adaptive weights can be computed based on the sample matrix. The STAP beam-forming processing unit can then multiply a 4-element vector for each beam, sub-band, Doppler and range involved.

Returning to FIG. 3, for this embodiment, an output of STAP processing unit 312 is connected to an input of CFAR processing unit 314. FIG. 9A depicts a block diagram of an example CFAR processing unit 900A that can be used to implement CFAR processing unit 314 in FIG. 3. For example, CFAR processing unit 900A can include a summing/averaging processing unit 902A (e.g., coupled to an output of STAP processing unit 312 via a shift register). An output of summing/averaging processing unit 902A is connected to an input of a local threshold establishment processing unit 904A. An output of the local threshold establishment processing unit 904A is connected to an input of a comparison processing unit 906A.

In operation, for this exemplary embodiment, the input to the CFAR processing function 900A is a real sequence formed from the magnitude of the returns for each range cell. For each range cell of interest, a window of N cells is formed around the cell of interest, and the average energy of the returns in the window (excluding the cell of interest and one or more “guard cells” on either side of the cell of interest is computed. This average is used to establish a local threshold which will be used to declare the presence or absence of a target when compared with the magnitude of the return in the cell of interest. The threshold is set to maximize the Probability of Detection (P_{D}) and minimize the Probability of False Alarm (P_{FA}), while attempting to avoid the making of a decisional error, such as, for example, declaring no target when a target is actually present, or declaring a target when none is present. The “window” can be slid from cell to cell, or through the entire sequence of range cells. However, care must be taken when dealing with range cells on the extremes, because the window from which the samples are taken is not symmetric.

As such, a number of techniques may be used to compute the average and use the threshold. For example, the average can be computed from scratch each time. Also, a more computationally efficient approach realizes that, for the next movement of the window, most of the “sum” already exists. Adding the contributions from the leading edge of the window and the left-most guard cell from the previous window, and subtracting the contributions from the trailing edge of the window and the right-most guard cell from the previous window, is all that is needed to create the new sum. It is also possible to perform this summation as a sliding matrix multiplication of the input cells with a . . . 111110000011111 . . . mask.

FIG. 9B depicts a block diagram of a second example CFAR processing unit 900B that can be used to implement CFAR processing unit 314 in FIG. 3. As such, CFAR processing unit 900B is a 2-dimensional (range and Doppler) CFAR, while CFAR processing unit 900A in FIG. 9A is a 1-dimensional (range) CFAR. For this example, CFAR processing unit 900B can include an extraction processing unit 902B for extracting a cell of interest from the input, and zeroing out the cell and guard cells. An output of extraction processing unit 902B is connected to an input of a summing/averaging processing unit 904B. An output of summing/averaging processing unit 904B is connected to an input of a local threshold establishment processing unit 906B. An output of the local threshold establishment processing unit 906B is connected to an input of a comparison processing unit 908B.

In accordance with the present invention, the output of CFAR processing unit 900A in FIG. 9A or 900B in FIG. 9B is detected video/target information with enhanced clutter suppression due to the use of DPCA and STAP processing techniques. This video/target information can be transferred to the ground via the communication subsystem unit 226 and coupled to a video/target display for use by an operator (e.g. from CFAR processing unit 314 in FIG. 3 at the back end of the programmable onboard processing subsystem 214 shown in FIG. 2).

In operation, CFAR processing unit 900B can perform a 2-dimensional CFAR function. A sliding window cell-averaging algorithm can be used for sizing purposes. A primary difference between the 2-dimensional CFAR in FIG. 9B and the 1-dimensional CFAR in FIG. 9A is that the local averaging is accomplished in the 2-dimensional CFAR 900B in FIG. 9B using the Doppler cell of interest and adjacent Doppler cells above and below the Doppler cell of interest. However, no guard banding is used in the Doppler dimension (i.e., all range gates in the adjacent Doppler cells are included in the average and subsequent threshold determinations).

It is important to note that while the present invention has been described in the context of a fully functioning radar processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular radar processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A system for suppressing clutter in a radar system, comprising:
an antenna stage;
a transmitter stage, said transmitter stage coupled to said antenna stage; and
a receiver stage, said receiver stage coupled to said antenna stage, said receiver stage including:
means for coupling received signals from said antenna stage to said receiver stage;
a displaced phase center antenna processing unit connected to said means for coupling received signals from said antenna stage to said receiver stage; and
a space-time adaptive processing unit coupled to said displaced phase center antenna processing unit.

2. The system of claim 1, further comprising:
a beam-forming processing unit, an input of said beam-forming processing unit connected to an output of said displaced phase center antenna processing unit;
a Doppler processing unit, an input of said Doppler processing unit connected to an output of said beam-forming processing unit; and
a pulse compression processing unit, an input of said pulse compression processing unit connected to an output of said Doppler processing unit, and an output of said pulse compression processing unit connected to an input of said space-time adaptive processing unit.

3. The system of claim 1, wherein said means for coupling received signals from said antenna stage to said receiver stage comprises an analog-to-digital converter.

4. The system of claim 1, wherein the radar system comprises a radar system located on a moving platform.

5. The system of claim 1, wherein said antenna stage comprises a phased array.

6. The system of claim 1, wherein said antenna stage comprises an adaptive array.

7. The system of claim 1, wherein said antenna stage comprises a displaced phase center antenna means.

8. The system of claim 1, wherein said displaced phase center antenna processing unit further comprises:
a first antenna segment, said first antenna segment including a first phase center; and
a second antenna segment, said second antenna segment including a second phase center.

9. The system of claim 1, wherein said space-time adaptive processing unit further comprises:
a sample matrix creation means;
an adaptive weight computation means coupled to said sample matrix creation means; and
a beam-forming matrix multiplication means.

10. A moving target indication system for a radar receiver comprising:
means for coupling received signals from the radar receiver to the moving target indication system;
a displaced phase center antenna processing unit connected to said means for coupling received signals from the radar receiver to the moving target indication system; and
a space-time adaptive processing unit coupled to said displaced phase center antenna processing unit.

11. The moving target indication system of claim 10, further comprising:
a beam-forming processing unit, an input of said beam-forming processing unit connected to an output of said displaced phase center antenna processing unit;
a Doppler processing unit, an input of said Doppler processing unit connected to an output of said beam-forming processing unit; and
a pulse compression processing unit, an input of said pulse compression processing unit connected to an output of said Doppler processing unit, and an output of said pulse compression processing unit connected to an input of said space-time adaptive processing unit.

12. The moving target indication system of claim 10, wherein said displaced phase center antenna processing unit further comprises:
a first antenna segment, said first antenna segment including a first phase center; and
a second antenna segment, said second antenna segment including a second phase center.

13. The moving target indication system of claim 10, wherein said space-time adaptive processing unit further comprises:
a sample matrix creation means;
an adaptive weight computation means coupled to said sample matrix creation means; and
a beam-forming matrix multiplication means.

14. A method for suppressing clutter in a radar system, the method comprising the steps of:
coupling received signals from a radar receiver to a displaced phase center antenna processing unit;
processing said received signals;
coupling said processed signals from said displaced phase center antenna processing unit to a beam-forming processing unit;
performing beam-forming processing on said processed signals;
coupling said beam-forming processed signals from said beam-forming processing unit to a Doppler processing unit;
performing Doppler filtering on said beam-forming processed signals;
coupling said Doppler filtered signals from said Doppler processing unit to a pulse compression processing unit;
performing pulse compression processing on said Doppler filtered signals;
coupling said pulse compressed signals from said pulse compression processing unit to a space-time adaptive processing unit; and
performing space-time adaptive processing on said pulse compressed signals.

15. The method of claim 14, wherein the step of processing said received signals further comprises the step of algebraically subtracting a first signal received from a first phase center associated with a first antenna segment from a second signal received from a second phase center associated with a second antenna segment.

16. The method of claim 14, wherein the step of performing said space-time adaptive processing further comprises the steps of:
creating a sample matrix;
computing a plurality of adaptive weights for a plurality of samples in said sample matrix; and
multiplying said plurality of adaptive weights with a signal comprising a form of said samples in said sample matrix.

17. The method of claim 14, further comprising the step of determining a target threshold value and constant false alarm rate for said space-time adaptive processed signal.

18. The method of claim 14, wherein the steps are performed by a coherent moving target indication processing system.

19. The method of claim 14, wherein the radar system is located on a moving platform.

20. The method of claim 14, wherein the steps of processing the received signals and performing space-time adaptive processing are performed by a displaced phase center antenna processing unit and space-time adaptive processing unit, respectively.
